(19) United States
(12) Patent Application Publication
(10) Pub. No.: US 2024/0270360 A1
(43) Pub. Date: Aug. 15, 2024

(54) SAIL PROPULSION ELEMENT, SAIL-PROPELLED VEHICLE

(71) Applicant: COMPAGNIE GENERALE DES ETABLISSEMENTS MICHELIN, Clermont-Ferrand (FR)

(72) Inventors: OLIVIER ESSINGER, Clermont-Ferrand (FR); BRUNO FRAGNIERE, Clermont-Ferrand (FR); EDOUARD KESSI, ST-PREST (CH); LAURENT DE KALBERMATTEN, Riaz (CH)

(21) Appl. No.: 18/564,737

(22) PCT Filed: May 30, 2022
(86) PCT No.: PCT/FR2022/051017

§ 371 Date: Nov. 28, 2023

(30) Foreign Application Priority Data
May 28, 2021 (FR) FR2105604

(51) Int. Cl. B63H 9/061; B63H 9/10

(52) U.S. Cl. CPC B63H 9/0615; B63H 9/1021

(57) ABSTRACT

A sail propulsion element comprises a mast (3), an inflatable sail (1) consisting essentially of two substantially fluidtight adjacent surfaces (5) joined together along their periphery, thus forming at least one closed cavity, at least one air conduit positioned between the inside and the outside of the cavity, at least one means for injecting air into the cavity, the sail once inflated having a profile that remains permanently symmetrical, irrespective of the movement of the propulsion element, or of the direction or strength of the wind, a headboard (10), a sail receptacle (11), and at least one guide line (12) positioned in the closed cavity of the sail, for the maneuvers of hoisting and dropping the sail, the guide line extending from a leading edge (8) to a trailing edge (9) of the sail, passing through the headboard (10) and the sail receptacle (11).

The invention relates to an inflatable sail, and falls within the field of sail propulsion or that of hybrid sail propulsion.

A reminder of some definitions used hereinafter is given below:
Reefing: consists in reducing the surface area of a sail by partly furling it from the bottom so as to adapt the surface area of the sail to suit the strength of the wind. The reefing may be done manually or automatically.
Reefing bands: partially reinforced horizontal zones to which reefing turning blocks can be attached, with, for example, grommets or pulleys These reefing bands are positioned on the sail at the rib at each height at which the sail has a reefing point. There are as many reefing bands as there are possibilities to reef the sail.
Lazy jacks: devices for guiding the sail during the operations of reefing and of dropping the sail.
Boom: horizontal spar articulated close to the base of the mast and which holds and permits orientation of certain sails. The boom may also receive the sail when the sail has been dropped.
Luffing: a sail which is luffing is insufficiently hauled in and has therefore partially deflated. A well-trimmed sail needs to be on the limit of luffing. With a properly filled sail there is no luffing so it is possible to sail close to the wind.
Leading edge: the front part of an aerodynamic profile (wing, propeller, etc.) at which a fluid will divide into two streams.
Trailing edge: a characteristic part of any profile (wing, keel, rudder blade, etc.) subjected to a flow of a fluid (air, water, etc.) on each side of it. It designates the part opposite to the sense of direction or, in other words, the rear part when considered in the direction of the flow.
Headboard: the upper end of the sail which conforms to the upper contour of the inflatable sail.
Dropping: consists in lowering the sail.
Hoisting: consists in raising the sail.
Rigging: collection of fixed and moving parts of a boat of the sailboat type that allows the boat to be propelled and manoeuvred using the force of the wind.
Sail receptacle: in addition to receiving the dropped sail, it may incorporate other functions, such as reacting the tension supplied by the sail or else housing other actuators, energy storage sensors and control module used for operating the sail.
Hydrodynamic drag: the force of friction between the boat and the water. The higher the drag, the more the boat is slowed.
Aerodynamic drag: a component of the force experienced by a body moving through a fluid and that is exerted in the opposite direction to the direction of the movement. According to the invention, the sail generates aerodynamic drag.
Aerodynamic lift: a component of the force experienced by a body moving through a fluid and that is exerted perpendicular to the direction of the movement. According to the invention, the sail generates aerodynamic lift.
Relative wind or apparent wind: the vector sum of the wind created by the inherent speed of the boat and the actual windspeed.
Aerodynamic resultant: the vector sum of the aerodynamic lift and of the aerodynamic drag.

### PRIOR ART

A sail propulsion element comprising an inflatable sail with a symmetrical profile is already known from document WO 2017/221117A1. This propulsion element comprises an inflatable sail consisting essentially of two substantially fluidtight adjacent surfaces joined together along their periphery, thus forming at least one closed cavity. The element further comprises a conduit positioned between the inside and the outside of the cavity and means for injecting air into the cavity. Once inflated, this sail has a profile that remains permanently symmetrical, irrespective of the movement of the element, or of the direction or strength of the wind. The sail in that document is constantly being inflated while it is being used for sailing.

Unfortunately, a soft sail such as this has the disadvantage of not offering a level of inflation that is suited to the various stages of its use, notably during the hoisting and dropping phases. Specifically, unlike a hard sail, a soft sail has no clearly defined position for these stages of handling (hoisting and dropping). During these stages, it is important to keep the sail close to the axis of symmetry of the sail profile, so as to avoid the sail falling in the water or becoming caught on an element close by, or collapsing in an ill-defined heap such that it cannot be stowed compactly. Moreover, it is important to maintain a slight pressure in the sail during the dropping or reefing phase so as to prevent it from luffing, as this could reduce its life.

A device for hoisting and dropping a conventional sail of a sailboat using a guiding solution external to the sail is also known from document US2006174810A1. This handling can be performed easily one-handed, and can be controlled, during lowering or during hoisting, continuously at absolutely any intermediate position, allowing the sail to be adapted quickly to suited different wind conditions.

Unfortunately, such a sail management device is positioned on the outside of this sail, leading to an increase in drag. Moreover, such a device, being fixed to the boom and to the mast, cannot be fitted to a telescopic mast.

Document GB2151199A describes an inflatable boat sail comprising in its internal cavity a system of flexible mechanical links, of lacing type, connecting the two walls that form the sail. This system is arranged over the entire height of the sail and is fixed in the lower part of the mast. Its purpose is to allow optimal operation of the sail from an aerodynamic standpoint in these various usages.

Unfortunately, such a system is not suitable for managing the repeated hoisting and dropping of an inflated sail, and remains complex.

Finally, those skilled in the art know of the use of line rope cordage devices external to a conventional sail, fixed to the boom, and intended for boom handleability during hoisting and dropping manoeuvres.

However, such devices increase the drag of the sailboat, therefore penalizing its speed, and cannot be fitted to telescopic masts.

### SUMMARY OF THE INVENTION

Thus there is still a need for an inflatable sail which, during dropping, remains correctly on its axis of symmetry along the mast, without luffing, and without risk of becoming damaged, and which can be deployed repeatedly, either manually or automatically.

One subject matter of the invention is a sail propulsion element, comprising a mast, an inflatable sail consisting essentially of two substantially fluidtight adjacent surfaces joined together along their periphery, thus forming at least one closed cavity between them, said sail comprising an upper part, a lower part, a leading edge and a trailing edge, the sail comprising various cambers forming bulges along its entire length, at least one air conduit positioned between the inside and the outside of the cavity of the sail, at least one means for injecting air into said cavity, the sail once inflated having a profile that remains permanently symmetrical, irrespective of the movement of said propulsion element, or of the direction or strength of the wind, a headboard positioned on the upper part of the sail, and a sail receptacle positioned between the leading edge and the trailing edge on the lower part of the sail.

The propulsion element according to the invention is characterized in that it comprises at least one guide line positioned in the closed cavity of said sail, for the manoeuvres of hoisting and dropping the sail, said guide line extending from the leading edge to the trailing edge of said sail, passing through the headboard and the sail receptacle.

More specifically, the guide line is a device produced through line rope cordage to allow the sail to be correctly geometrically positioned during operation and during the phases of hoisting or dropping. The inflatable sail (or wing) comprises several cambers (or compartments) separated from one another by ribs, a rib being situated between two adjacent cambers. A rib of the sail, for example considered midway up the height of this sail, is positionally constrained by the fact that it allows the mast to pass through an orifice formed for that purpose in the rib, but apart from the rigidity of the sail (which is low) there is nothing to prevent it from rotating about the mast under the effect of the pressures applied to the sail. Such rotation would have the effect of causing the sail to twist therefore leading to poor performance. To avoid this twisting, each rib has the guide line passing through it at a point sufficiently distant from the mast. During hoisting or dropping, the rib slides along the mast and along this guide line. The same is true of all the ribs of the cambers of the sail, the guide line passing through all of these ribs.

In other words, the invention proposes at least one guide line positioned in the closed cavity of said sail and intended to assist with the manoeuvres of hoisting and dropping the sail and making it possible to ensure that the inflated sail (or wing) maintains the correct geometry under all of the operating conditions of this sail.

This guide line is not intended for hoisting the sail. It is moreover slightly under tension during the hoisting phase and for this very reason opposes the raising of the sail. In the context of the invention, the sail is hoisted by the telescopic mast that supports the headboard, which pulls the sail upwards as this sail inflates. In the invention variant in which the mast is not telescopic, the sail is hoisted by the movement of the headboard along the mast.

The propulsion element according to the invention offers the following various advantages. The guide line present in the cavity of the sail avoids the needless generation of additional drag, unlike conventional rigging. The guide line according to the invention allows the lowering and raising of the sail to be guided correctly (which means without twisting) towards its stowage location situated on the sail receptacle. The guide line according to the invention makes it possible to have a relatively low tension (around 50N for an approximately 100 m² sail) in the sail.

Finally, the element according to the invention allows the sail to be reefed without the need to stop the boat. Only the sail needs to face into the wind, unlike the hitherto-known devices which require the entirety of the boat to face into the wind.

As a preference, the guide line is in one part and is attached fixedly to the sail receptacle on the trailing edge and able to be moved by a roller on the leading edge, or else is able to be moved by a roller in the sail receptacle on the trailing edge and fixedly attached to the leading edge, and in that the guide line is positioned along the headboard such as to be able to move over at least one pulley between the trailing edge and the leading edge.

As a preference, the guide line is in two parts, the first part on the side of the trailing edge being fixed or else able to be moved with a pulley on the headboard and able to be moved by a roller in the receptacle, the second part on the side of the leading edge being fixed or else able to be moved with a pulley on the headboard and able to be moved by a roller in the receptacle.

As a preference, a pulley makes it possible to limit friction by comparison with a grommet.

As a preference, at least two guide lines make it possible to improve the precision of the guidance. The presence of several guide lines preferentially makes it possible to spread the load and thus increase the precision of the guidance. The reefing points may also help with guidance.

As a preference, the guide line has a length ranging from around 2 to 150 m for a sail ranging from 10 to 1000 m², and preferably of around 50 m for a 100 m² sail.

As a preference, the guide line has a tension ranging between 5 and 500N for a sail ranging from 10 to 1000 m², and preferably of around 50 to 250N for a 100 m² sail.

As a preference, the sail comprises at least one reefing panel, and more particularly from 0 to 10 reefing panels. Cargo vessels may have no reefing points while the mainsails of sailboats may have more than 3.

As a preference, each reefing panel comprises a reinforced rib.

As a preference, the mast is fixed or telescopic.

As a preference, the guide line is made of ultra-strong polyethylene fibres.

Another subject matter of the present invention is a vehicle with sail propulsion or hybrid propulsion comprising at least one sail-propulsion element as mentioned hereinabove, a hull and a mast secured to said hull but still free to rotate. This vehicle is characterized in that the mast is positioned inside the cavity of the above-mentioned inflatable sail.

What is meant by a hybrid-propulsion vehicle according to the invention is sail propulsion coupled with another source of propulsion such as, for example, propulsion by means of a propeller driven by an electric motor or a combustion engine, having, as energy store, batteries, hydrogen (with fuel cell), natural gas, ammonia or fuel oil.

What is meant by a vehicle is a land yacht, an ice yacht, a boat, a car.

As a preference, the sail is oriented according to the direction of the wind and according to the direction of travel of the vehicle, either manually or automatically, so as to optimize the thrust along the axis of the boat or so as to achieve the desired thrust while at the same time limiting loads, pressures and heeling to acceptable values.

### DESCRIPTION OF THE DRAWINGS

The invention will be described with the aid of the following figures, which are schematic and not necessarily drawn to scale, and in which:

FIG. 1 provides a reminder of the various physical forces that are applied to a ship, for example of the motor sailboat type and notably the projection of the resultant aerodynamic force;

FIG. 2 depicts a schematic view in cross section of a sail-propulsion element according to the invention, positioned on a boat hull;

FIG. 3 depicts a schematic view in cross section of a sail-propulsion element according to another variant of the invention, positioned on a boat hull;

FIGS. 4A, 4B and 4C each depict a schematic view from above of the position of the propulsion element according to the invention according to different relative-wind angles.

Before the sail-propulsion element that forms the subject matter of the present invention is explained in greater detail, with the aid of the above-mentioned figures, a reminder of a few hydrodynamic and aerodynamic definitions is given below.

A sail-propulsion vehicle, hereinafter referred to as sailboat or ship, is in contact with the air and with the water. From a physical standpoint, the predominant factors are the hydrodynamic and aerodynamic forces that are applied to the hull, the sails and the appendages (centreboards, keel, rudder, propeller).

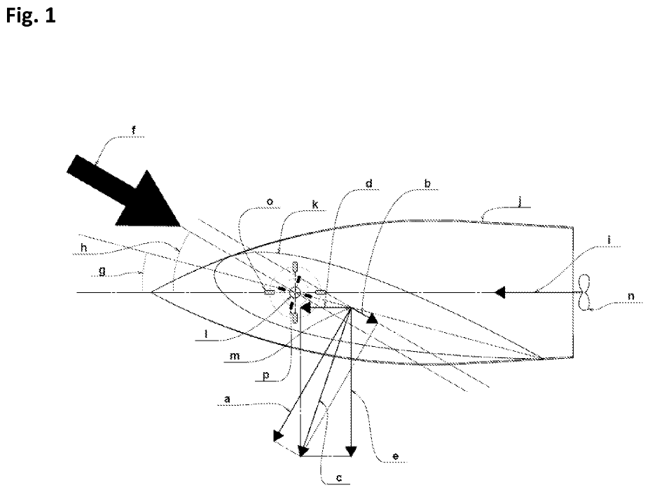

As shown in FIG. 1, the aerodynamic force (or sail thrust) is the result of the air being deflected by at least one sail. The aerodynamic force is relative to the position and surface area of the sail and to the position and strength of the relative wind. The drag force is in the direction of the relative wind, the lift force is in the direction perpendicular to the relative wind, and is not always perpendicular to the sail. For example, at 0°, a symmetrical profile creates no lift because the air covers strictly the same distance over the extrados surface and the intrados surface. At that point, it generates only drag.

The aerodynamic force generated by the sail may also be broken down in the frame of reference of the boat, rather than that of the sail, into a sail-propulsion force (along the axis of travel of the boat) and a drift force (perpendicular to the axis of the boat) which may cause a boat to heel (heeling being the transverse inclination of a boat as caused by an external phenomenon such as the wind).

The hydrodynamic force is the result of the friction of the water against the hull and the centreboard or keel and the various underwater appendages. Its direction is dependent on the aerodynamic force that it opposes, on the propulsion force in hybrid mode, on the sea state and on the marine currents. The longitudinal component is referred to as hydrodynamic drag and the transverse component is referred to as side force, anti-heeling force or hydrodynamic lift. The direction and the intensity of the hydrodynamic force are not dependent solely on the aerodynamic force. For a surface vessel (boat) operating in hybrid mode (wind and another energy source), the hydrodynamic force will be greatly dependent on the vessel speed generated by the engine or motor propulsion, for example, on the sea state and on the marine currents.

When the sail force is greater than the hydrodynamic force, the boat accelerates. When the sail force is lower than the hydrodynamic force, the boat slows down. Further, if the aerodynamic force is greater, but directed towards the rear of the boat, the boat will slow down. If the hydrodynamic force is in the direction of travel of the boat (for example as a result of a strong current), the boat (sailboat) will accelerate.

It is by optimizing the trim of the sail that the boat (sailboat) will achieve its maximum performance in terms of sail thrust in the direction of travel. Specifically, it is by optimizing the angle of the sail relative to the relative wind and to the direction of the boat, and by trimming the surface area of the sail, that the boat can be made to achieve the maximum level of sail propulsion along the axis of the boat. Added to this there may be an additional trimming parameter involving altering the internal pressure of the sail. This then makes it possible to increase the speed of the boat or, on the other hand, to maintain the same speed while at the same time reducing the consumption of other energy sources, in favour of sail power.

FIG. 1 repeats each of the foregoing defined parameters with its own specific reference, all as listed hereinbelow:
a: Lift force
b: Drag force
c: Aerodynamic resultant force
d: Aerodynamic thrust force (along the axis of the ship)
e: Aerodynamic drift force
f: Relative wind
g: Relative angle between wing and boat axis (e.g. 15°)
h: Angle between relative wind and boat axis (e.g. 30°)
i: Propeller propulsion force
j: Hull
k: Sail
l: Mast
m: Centre of aerodynamic thrust
n: Propeller
o: sensor on fixed part (hull frame of reference)
p: sensor on moving part (sail frame of reference)
   The information given in FIG. 1 allows transition from sensors of data in the frame of reference of the hull to the sensors of data in the frame of reference of the sail, and vice versa.

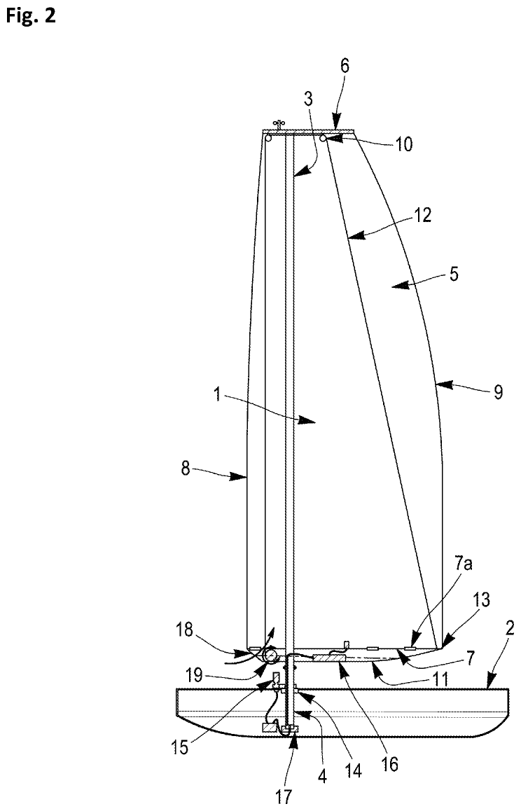

FIG. 2 depicts the sail propulsion element according to the invention, mounted on a boat, of the sailboat type, in the position of operation. This element comprises a sail of overall reference 1 mounted on the hull 2 of a boat. The element comprises a mast 3 of which the foot 4 is fixed to the hull 2 while still allowing the mast 3 a rotational movement. The mast 3 is self-supporting. The mast 3 is connected to the hull 2 using a support (not depicted) intended to absorb the load of the physical forces and leave a degree of freedom to rotate. Loads are measured at the support(s). The sail 1 comprises two adjacent surfaces 5 (only one can be seen in the figure) connected to one another in such a way as to form a closed cavity. The material used for the two adjacent surfaces 5 needs to limit permeation so as to reduce air consumption and allow the various loads involved to be reacted and transmitted. In certain cases it may be necessary to add various treatments to the material so as to ensure, for example, a certain UV resistance or else an antistatic behaviour.

The sail 1 has several cambers (not depicted) evenly distributed over the height (the cambers are greater in the lower part of the sail and smaller in the upper part). The height of the camber is often linked to the length of the cord of the profile. As a preference, the cambers are separated by ribs that allow air to pass from one camber to another and that each have an orifice that the mast can pass through.

The cambers give it the external appearance of a concertina. The sail 1 comprises an upper part 6, a lower part 7, a leading edge 8 and a trailing edge 9. At least one air inlet 18 is positioned, for example, at the lower part 7 of the sail 1. Other air inlets 30 may also be positioned on the surface of the leading edge 8. At least one active means 7a for injecting air into the cavity of the sail is positioned in the continuation of the air conduit so that air can be injected into the cavity of the sail. The sail further comprises a headboard 10 positioned on its upper part 6, and the sail receptacle 11 positioned on its lower part 7 between the leading edge 8 and the trailing edge 9. This receptacle 11 is intended to receive all or part of the sail when it is dropped. This receptacle 11 may comprise various actuators and sensors facilitating the manual or automatic manoeuvre of hoisting or dropping the sail 1.

The sail propulsion element according to the invention comprises a guide line 12 positioned inside the cavity of the sail 1. This guide line is intended for guiding the sail during the manoeuvres of hoisting and of dropping, and of reefing the sail 1. This line 12 comprises line-rope cordage that extends substantially over the perimeter of the sail 1. The guide line 12 is fixed removably or non-removably, but such that it is not able to move, at an end 13 situated close to the intersection between the trailing edge 9 and the sail receptacle 11. It then extends towards the upper part 6 of the sail 1, to run along the headboard 10 between the trailing edge 9 and the leading edge 8. The guide line 12 is able to move along the headboard 10 with the aid of at least two pulleys or other possible turning-block systems (which have not been depicted), each one positioned one each side of the mast 3. This guide line 12 is adjacent to the leading edge 8, towards the sail receptacle 11 and is then fixed using a roller 19 on the sail receptacle 11 substantially at the leading edge 8. The guide line 12 may be brought up towards a fastening-off cleat, if it is actuated manually. On the other hand, for the automated version, it is wound onto an automatic roller.

More specifically, the cordage of the guide line passes through all of the ribs that separate the various cambers that form the inflatable sail. In order to prevent the various ribs from rotating about the mast, each rib has one oblong slot through which the cordage of the guide line passes on the leading-edge side, and another oblong slot through which the cordage of the guide line passes on the trailing edge side. The oblong slot allows the line-rope cordage to pass through the ribs in all of the positions that these ribs adopt along the mast when the sail is being hoisted and dropped. In this way, the ribs are prevented from rotating about the mast despite the fact that the ribs, as well as the sail, are made from a flexible material, thereby allowing the sail to maintain its profile during operation and especially during the manoeuvres of hoisting and of dropping said sail.

Unlike a system of the prior art, of the type using lazy-jacks on the outside of the sail, and permanently fixed, the cordage of the guide line of the invention is on the inside of the sail and its length is adjusted to ensure a slight tension that keeps the inflatable sail (or wing) in the correct position. This cordage will move with the headboard situated at the top of the sail so as to always ensure a slight tension in the cordage of the guide line.

The guide line 12 has a length of around 50 m for a sail having a total surface area of around 100 m², and a tension of between around 50 and 250N depending on the uses to which it is being put during the various dropping and hoisting manoeuvres.

The mast 3 may be telescopic or fixed. When the mast 3 is telescopic, the headboard 10 is secured to the last element of the telescopic mast 3, able to maintain a degree of freedom to rotate, either with respect to the mast or by way of the last element of the telescopic mast being itself able to rotate. When the mast 3 is telescopic, it is made up of various elements which slide successively on one another in order to extend or retract. It is also possible to extend all of the elements at the same time, if intermediate sail positions are not needed.

When the mast 3 is fixed, only the headboard 10 is able to move along the mast 3. The sail 1, being fixed to the headboard 10, is raised or lowered therewith.

It is also possible to combine a telescopic mast 3 and a headboard 10 that slides along the mast 3.

The headboard 10 has enough rigidity to be able to impart the physical forces there are between the various line ropes and the mast 3 and also to withstand the weight of the sail when the sail is not inflated. According to the various embodiments of the invention, the headboard 10 may, as desired, be free to rotate about the mast 3, prevented from rotating about the mast 3, prevented from rotating about the mast 3 up to a limiting torque value so as to limit loads to an acceptable value, or alternatively feedback controlled in such a way as to control the twisting of the sail.

The mast 3 is fixed to the hull 2 using a mast support 14 the purpose of which is to react the various physical forces between the sail and the boat while at the same time leaving the mast 3 a degree of freedom to rotate so that it can position itself at the correct angle with respect to the relative wind.

At the foot of the mast 3, at the hull 2, there is a system 15 for adjusting the angle of incidence so as to make it possible to command the sail 1 to rotate by turning the mast 3 and all the manoeuvring components fixed to said mast 3. This system 15 may consist, amongst other things, of a brake motor. This system 15 allows the sail 1 to be able to rotate about the axis of rotation of the mast 3 and therefore makes it possible to command the desired angle of incidence of the sail 1. This system for setting the angle of incidence may also be mounted fixedly relative to the mast 3, for example on the “nest” (or sail receptacle), with a brake motor driving, via a pinion, a ring gear fixed to the hull.

It will be recalled that measuring the angle of incidence makes it possible to determine the angular positioning of the sail 1 with respect to the axis of the boat. Such a device allows the sail 1, the hull 2 and the relative wind to be placed in the one same frame of reference, whatever the point at which the wind is measured on the sail 1 or on the hull 2. Such a system simplifies sailing in automatic mode.

The propulsion element according to the invention, positioned on the hull of a boat, may also be combined with a torque limiter, positioned at the foot of the mast 3 and known for limiting the maximum torque that the sail 1 can transmit to the hull 2.

The propulsion element according to the invention, positioned on the hull of a boat, may further comprise an electronic control system 16 positioned in the sail receptacle 11 also referred to as the “nest”. A rotary electrical joint 17 may also be added in the hull at the lower base of the mast 3. This joint 17 allows electrical power and electrical commands to be transmitted between the hull 2 and the lower part 7 of the sail 1. The joint 17 may also be replaced by a suitable conventional cable-bearing chain. When the power used to actuate the sail element according to the invention is, for example, hydraulic or pneumatic power, the same solution can be adopted with a rotary hydraulic or pneumatic joint.

Amongst the various measurement sensors, there may be sensors for measuring the load transmitted from the sail 1 to the hull 2, sensors for measuring the load in the transverse axis of the hull 2, sensors for measuring load in the longitudinal axis of the hull 2, the sensor for pressure in the internal cavity of the sail 1, and the sensor that measures the speed and angle of the relative wind. This last measurement may equally well be taken on the sail 1 or on the hull 2. In instances in which the sensors are positioned on the part secured to the mast 3, they measure the loads along the longitudinal axis and the transverse axis of the sail 1.

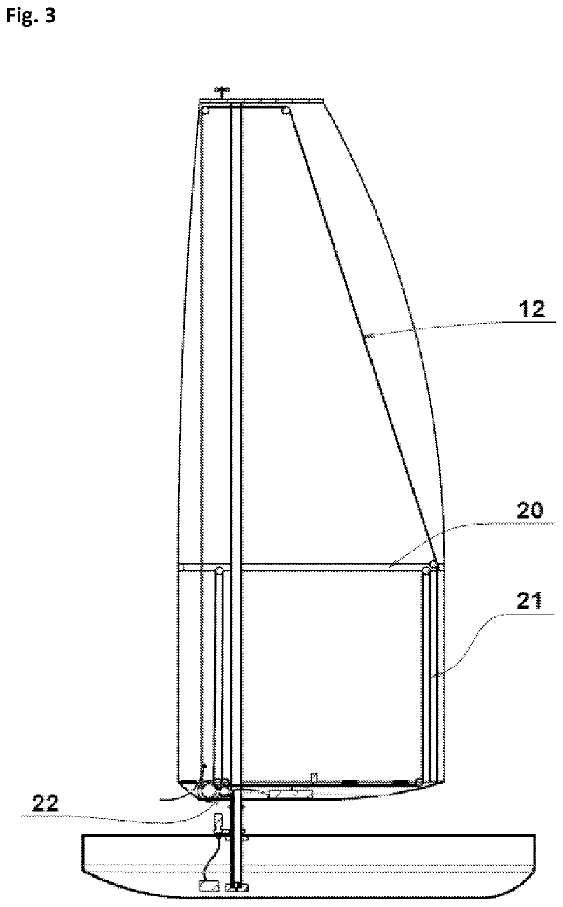

FIG. 3 differs from FIG. 2 through the additional presence of a reefing pendant system made up of a reefing panel (or grid) 20, of a reefing line 21 and of a reefing winch 22 (the reefing winch may be replaced by a cleat and muscle power in manual mode).

The propulsion element according to the invention may comprise several reefing panels 20, for example up to 3 of them. The number of these panels 20 is dependent on the boat, on the use, and on the user. The roofing panels 20 are positioned at each reefing band.

The reefing line is connected to the reefing panel 20 and allows the sail 1 to be returned and compacted into the receptacle 11. The grid has enough rigidity that the point-loading at the pulley, which is fixed to the grid, can be transmitted to the entirety of the reefing panel 20.

Associated with each reefing point intended for reducing the amount of sail to a certain level there is a reefing panel 20 and a reefing line. The reefing line may be produced either as a single line with turning blocks or as separate lines.

In conventional sails of the prior art, each reefing point has grommets, associated pulleys through which the reefing pendant can pass in order to perform reefing, or sail ties (small lengths of cord which can be used to attach the furled sail by passing them down under the boom from each side).

For the inflated sail according to the invention, the grommets (or other lead-throughs) are positioned not on the vertical part of the sail as in a conventional sail, but on the horizontal part of the reefing panel 20, which must not be fluidtight.

As a result, the reefing panel 20 (or grid) in the propulsion element of the invention is fixed to the external wall of the sail 1. This panel 20 allows, in addition to reefing, the guide line 12 to be brought closer to the trailing edge 9 and to the leading edge 8, especially in the case of sails that are not substantially triangular. In addition, the guide line 12, combined with the panel 20, allows the loads exerted on the headboard 6 to be partially equalized because it applies a downward thrust to the headboard 6 on each side of the mast 3 simultaneously.

The reefing panel 20 allows, in addition to reefing, the guide line 12 to be brought closer to the leading edge 8 to the trailing edge 9, especially in the case of sails that are not substantially triangular in shape.

During the sail hoisting manoeuvre, the following steps are performed:
The sail is brought on to the axis of the relative wind,
An initial tension is applied to the guide line and to the reefing lines,
The sail is inflated to a low pressure, and this pressure is feedback controlled,
The sail is raised at a defined speed with a speed limiter if the internal pressure cannot be maintained,
Once the sail has been raised to a certain height, the pressure in the sail is increased slightly.
When the reefing points are reached, the reefs are successively let out if the surface area is to be used.
The raising of the sail is halted when the sail surface area is reached; this raising then corresponds either to the sail being fully deployed, or to the sail being at a height corresponding to the amount of reefing in place,
The sail cavity is inflated to the nominal pressure (which is dependent on the strength of the wind, on the sea state, on the desired speed of travel).
There is no need to permanently blow air into the sail. Specifically, it is possible to have a range of acceptable pressures thus making it possible to use the air injection means only when doing so is necessary.

During the sail dropping manoeuvre, the following steps are performed:
The sail is brought into the direction of the relative wind (facing into the wind),
The internal pressure of the cavity is reduced,
The tensions of the guide line and of the reefing lines is adjusted,
The sail is lowered with a speed limiter if the internal pressure cannot be maintained,
Each time a reef is reached, the relative reefing pendant is blocked off,
At 2 m from the final retraction of the mast, the internal pressure set point is set at zero in order to create a slight vacuum within the sail so as to compact same.

These various steps of manoeuvre are preferably automated, especially when the sail reaches a surface area that may equal or exceed 500 m². Manual manoeuvres can easily be achieved with surface areas of around 40 m², with a sufficient number of people.

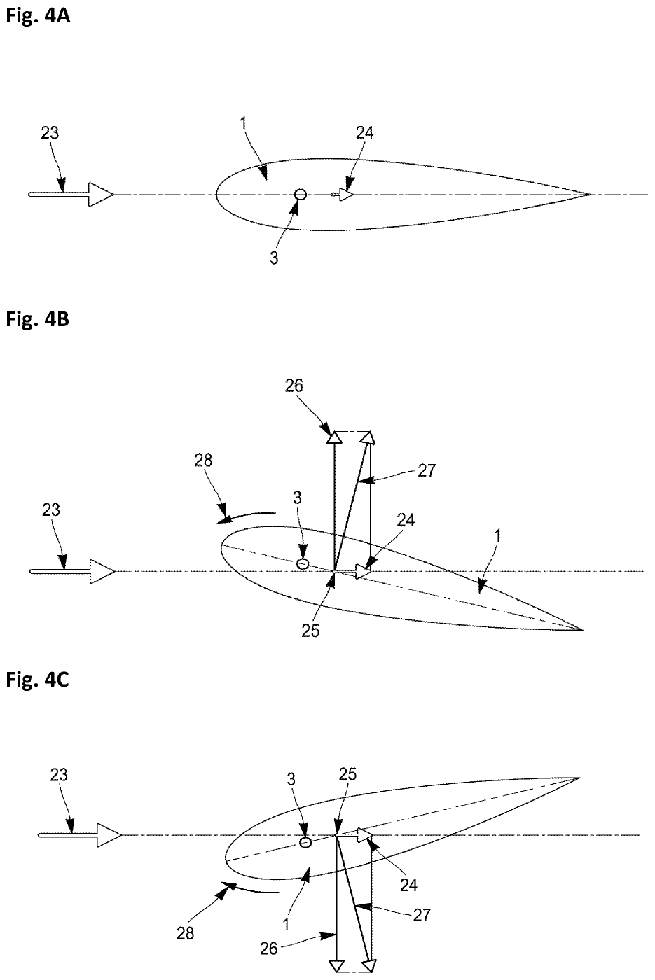

FIGS. 4A, 4B and 4C differ from one another by having a different sail angle of incidence.

In FIG. 4A, the relative wind is along the axis of the sail. In FIG. 4B, the axis of the sail is at an angle substantially equal to 15° with respect to the direction of the relative wind, and in FIG. 4C, the axis of the sail is at an angle symmetrical with and equal to that depicted in FIG. 4B with respect to the direction of the relative wind.

In FIGS. 4A, 4B and 4C, the sail 1 has a substantially symmetrical profile. The mast 3 is symbolized by a circle. The relative wind is symbolized by the arrow 23.

FIG. 4A depicts a sail 1 in a stabilized state facing into the wind 23. The various loadings are balanced; the aerodynamic lift is zero because it is identical on both sides of the wing because of its symmetrical profile. The aerodynamic lift is zero, there is only drag 24 which keeps the sail 1 on an axis parallel to the axis of the relative wind.

FIG. 4B depicts a sail 1 of which the axis is at an angle of around 15° with respect to the direction of the relative wind. The axis of rotation of the mast 3 is offset towards the front of the profile with respect to the centre of thrust 25 of the aerodynamic forces along the axis of symmetry of the profile. FIG. 4B shows that the torque generated by the aerodynamic force at a certain distance from the centre of rotation of the mast 3 has a tendency to return the sail towards its position facing into the wind, where it can remain stably thanks to the symmetrical profile of the sail.

The offset there is between the point of attachment of the mast 3 and the centre of thrust 25 allows the propulsion element of the invention to ensure that the sail 1 is held in place both in situations in which there is a large angular deviation from the direction of the wind and in situations in which there is a small angular deviation. Such an offset between this point of rotation of the mast 3 and the centre 25 means that the sail 1 can be made to return towards the neutral position of the sail, which is to say the position facing into the wind, when the sail deviates from that position. Such an offset makes it possible to improve the safety of sailing since the sail automatically returns to a suitable and optimal position with respect to the direction of the relative wind, thereby minimizing load and keeping the sail facing into the wind. However, this distance needs to be minimized so as not to overly increase the forces needed for rotating the sail.

FIG. 4C is the figure symmetrical with that of FIG. 4B with respect to the axis of the relative wind. The same observations as those in respect of FIG. 4B apply.

### EXAMPLE

The example which follows is given solely by way of illustration and is not limiting. The table below collates various possible situations.

| | Sailboat | Cargo vessel |
|---|---|---|
| Length of boat (in metres) | 13 | 140 |
| Number of sails | 1 | 4 |
| Sail internal layer in polyester | 220 | 240 |
| (g/m²) | | |
| Sail external layer in coated | 110 | 160 |
| polyester | | |
| Height of sail (in metres) | 17 | 40 |
| Longest length of sail (in metres) | 8 | 17 |
| Greatest width of sail (in metres) | 1.8 | 4 |
| Surface area of sail (m²) | 100 | 500 |
| Number of panels | 30 | 35 |

The external layer of the sail, also referred to as the body, is made from a woven fabric comprising an external part in contact with the exterior air, and an internal part. This fabric may be a woven polyester coated with polyurethane. The grammage of this fabric may be 180 g/m² for approximately 100 m² sail area.

The upper part of the sail may be secured using hook and loop strips of the Velcro type. The connections between the outer parts of the sail and the ribs (internal connections) and the connections between the constituent elements of the outer part may be achieved by fusion bonding or adhesive bonding or any other means of connection (zip-fasteners for example which are able to ensure both a sufficiently low level of permeation compatible with the existing inflation system while also ensuring that load is transmitted.

1.-13. (canceled)

14. A sail propulsion element comprising:
a mast (3);
an inflatable sail (1) consisting essentially of two substantially fluidtight adjacent surfaces (5) joined together along a periphery of the surfaces, forming at least one closed cavity between the surfaces, the inflatable sail comprising an upper part (6), a lower part (7), a leading edge (8) and a trailing edge (9), the inflatable sail comprising cambers forming bulges along an entire length of the inflatable sail;
at least one air conduit positioned between an inside and an outside of the at least one closed cavity of the inflatable sail;
at least one means for injecting air into the at least one closed cavity, the inflatable sail once inflated having a profile that remains permanently symmetrical, irrespective of movement of the sail propulsion element, or of a direction or strength of wind;
a headboard (10) positioned on the upper part (6) of the inflatable sail (1);
a sail receptacle (11) positioned between the leading edge (8) and the trailing edge (9) on the lower part (7) of the inflatable sail; and
at least one guide line (12) positioned in the at least one closed cavity of the inflatable sail, for the manuevers of hoisting and dropping the inflatable sail (1), the at least one guide line (12) extending from the leading edge (8) to the trailing edge (9) of the inflatable sail, passing through the headboard (10) and the sail receptacle (11).

15. The sail propulsion element according to claim 14, wherein the guide line (12) is made in one part and is attached fixedly to the sail receptacle (11) on the trailing edge (9) and able to be moved by a roller on the leading edge (8) or is able to be moved by a roller in the sail receptacle (11) on the trailing edge (9) and fixedly attached to the leading edge (8), and
wherein the at least one guide line (12) is positioned along the headboard (10) such as to be able to move over at least one pulley between the trailing edge (9) and the leading edge (8).

16. The sail propulsion element according to claim 14, wherein the at least one guide line (12) is made in two parts, a first part on a side of the trailing edge (9) being fixed or able to be moved with a pulley on the headboard (10) and able to be moved by a roller in the receptacle (11), and a second part on a side of the leading edge (8) being fixed or able to be moved with a pulley on the headboard (10) and able to be moved by a roller in the receptacle (11).

17. The sail propulsion element according to claim 14, wherein a pulley limits friction by comparison with a grommet.

18. The sail propulsion element according to claim 14, wherein at least two guide lines make it possible to improve the precision of the guidance.

19. The sail propulsion element according to claim 14, wherein the at least one guide line has a length ranging from around 2 to 150 m for an inflatable sail ranging from 10 to 1000 m².

20. The sail propulsion element according to claim 14, wherein the at least one guide line (12) has a tension ranging between 5 and 500N for an inflatable sail ranging from 10 to 1000 m².

21. The sail propulsion element according to claim 14, wherein the inflatable sail comprises at least one reefing panel.

22. The sail propulsion element according to claim 14, wherein the inflatable sail comprises from 0 to 10 reefing panels (20).

23. The sail propulsion element according to claim 21, wherein each reefing panel (20) comprises a reinforced rib.

24. The sail propulsion element according to claim 14, wherein the mast (3) is fixed or telescopic.

25. A vehicle with sail propulsion or hybrid propulsion comprising at least one sail propulsion element according to claim 14, a hull and a mast secured to the hull and free to rotate, wherein the mast (3) is positioned inside the at least one closed cavity of the inflatable sail.

26. The vehicle according to claim 25, wherein the inflatable sail (1) is oriented according to a wind direction and according to a direction of running of the vehicle either manually or automatically.
